(19) United States
(12) Patent Application Publication
(10) Pub. No.: US 2008/0087297 A1
(43) Pub. Date: Apr. 17, 2008

(54) Portble Dusting Tool

(76) Inventor: Fariborz Rahbar-Dehghan, Edmonton (CA)

Correspondence Address: FRASER CLEMENS MARTIN & MILLER LLC, 28366 KENSINGTON LANE, PERRYSBURG, OH, 43551, US

(21) Appl. No.: 11/813,471

(22) PCT Filed: Jun. 2, 2006
(86) PCT No.: PCT/CA06/00907

§ 371 Date: Jul. 6, 2007

Related U.S. Application Data
(60) Provisional application No. 60/688,336, filed on Jun. 8, 2005.

(51) Int. Cl. B08B 6/00; A47L 13/40

(52) U.S. Cl. 134/1; 15/1.52

(57) ABSTRACT

A dusting tool comprises a selectively activated duster actuator, and a duster member carrying a number of bristles and connected to the duster actuator. The bristles of the duster member have an enhanced electrostatic charge build-up capability. The duster actuator can be activated to actuate the duster member, which causes said bristles to become electrostatically charged and concomitantly causes dust to be dislodged from said bristles.

### CROSS-REFERENCE DATA

The present application claims conventional priority of U.S. provisional patent application No. 60/886,336 filed Jun. 8, 2005.

### FIELD OF THE INVENTION

The present invention relates to cleaning devices, and more particularly to a portable dusting tool for cleaning delicate surfaces.

### BACKGROUND OF THE INVENTION

Digital cameras comprise an electronic sensor, such as a charge-coupled device (CCD) sensor or Complementary Metal Oxide Semiconductor (CMOS) sensor, lodged in a sensor chamber of the camera, and onto which is projected the image of what is seen through the lens of the camera. This sensor can acquire the image projected thereon and convert it into electronic data, which is thereafter forwarded to data processing means provided on the digital camera. The data processing means then converts this electronic data into an image file of known format, such as in JPEG, TIFF or RAW formats, stored thereafter on the memory card of the camera. Of course, this sensor must remain as clean as possible, since impurities deposited thereon can undesirably alter the final image acquired by the camera.

It is inevitable that during normal use of a digital camera, its sensor will become exposed to the atmosphere and its airborne impurities, such as minute airborne dust particles. More particularly, on professional digital cameras having interchangeable lenses such as digital single-lens reflex (DSLR) cameras, the sensor inevitably becomes exposed to the atmosphere and its impurities whenever the lens is removed from the body of the camera, for example when switching lenses.

To clean the sensor of their digital cameras, and more particularly to remove dust particles from its surface, digital camera owners have come up with a number of cleaning methods.

A common cleaning technique used by digital camera owners is to blow air from a canned air duster directly about the surface of the sensor. This technique, in addition to blowing away the dust on the sensor, has the adverse effect of dispersing and not removing dust particles. An alternate technique is to blow canned air into the bristles of a brush and then sweeping the surface of the sensor with the brush. Pressurized air is blown on the bristles for two purposes: (1) for blowing away all impurities that may be present between the bristles of the brush, and (2) for electrostatically charging the bristles of the brush, and thus enhancing the brush's capacity to pick up dust particles present on the camera sensor.

However, this latter technique also has its drawbacks. Indeed, liquid sometimes squirts out of canned air dusters when air is blown on the bristles, and liquid can thereafter be undesirably smeared on the surface of the sensor when the brush is swept thereacross. Another disadvantage of using canned air dusters is that they are pressurized containers and it is prohibited to bring them aboard aircrafts, which can be inconvenient for travelling photographers for example. Furthermore, pressurized air duster cans are not reusable, and after such a duster has been emptied, it is disposed of and a new one must be purchased.

### SUMMARY OF THE INVENTION

The present invention relates to a dusting tool, comprising:
a selectively activated duster actuator;
a duster member connected to said duster actuator and carrying a number of bristles, said bristles having an enhanced electrostatic charge build-up capability;
   wherein said duster actuator can be activated to actuate said duster member, for electrostatically charging said bristles and for concomitantly causing dust to be dislodged from said bristles.

In one embodiment, said dusting tool is portable.

In one embodiment, said duster actuator is a rotary motor.

In one embodiment, the dusting tool comprises a casing into which said rotary motor is at least partially received.

In one embodiment, said duster member is a brush defining an elongated shank connected at a first end to said rotary motor, and carrying a tuft of said bristles at a second end.

In one embodiment, the dusting tool further comprises a brush connector releasably coupled to said rotary motor and carrying said brush, said brush being thus operatively and releasably coupled to said rotary motor through the instrumentality of said brush connector.

In one embodiment, said rotary motor defines a shaft, said brush connector defines a tubular socket portion and a coupling portion defining a cavity therein. In this embodiment, said brush connector is releasably connected to said rotary motor by friction-fitting at least a portion of said shaft inside said coupling portion cavity, and said brush is releasably connected to said brush connector by releasably friction-fitting said brush shank second end in said tubular socket portion.

In one embodiment, said brush, said brush connector and said rotary motor shaft define a common longitudinal axis, and upon activation of said rotary motor said brush is spun along said common longitudinal axis to cause said bristles to fan out radially for engendering centrifugal acceleration and expulsion from said tuft of bristles of dust particles lodged within said bristles.

In one embodiment, the enhanced electrostatic charge build-up capability of said bristles is imparted to said bristles during pre-processing by producing said bristles out of a material having inherent electrostatic charge build-up capabilities.

In one embodiment, said bristles are made of polyamide.

In one embodiment, each of said bristles has a thickness within the range of 40 to 60 micrometers.

In one embodiment, the electrostatic charge build-up capability of said bristles is imparted to said bristles during post-processing by applying a chemical to said bristles.

In one embodiment, the electrostatic charge build-up capability of said bristles is imparted to said bristles during post-processing by applying a ionization treatment to said bristles.

In one embodiment, said electrostatic charge build up capability of said bristles enables attraction of macroscopic particles up to 15 millimetres in total length.

In one embodiment, said electrostatic charge build up capability of said bristles enables attraction of microscopic particles down to 1 micrometre in total length.

The present invention also relates to a method for cleaning a dusting tool, said method comprising the steps of:
(a) providing a portable dusting tool, comprising a selectively activated duster actuator, and a duster member carrying a number of bristles and connected to said duster actuator, said bristles having an enhanced electrostatic charge build-up capability; and
(b) activating said duster actuator to actuate said duster member, to electrostatically charge said bristles and to concomitantly cause impurities lodged between said bristles to be dislodged therefrom.

In one embodiment, said duster actuator comprises a rotary motor defining a shaft, said brush connector defines a tubular socket portion and a coupling portion defining a cavity therein, and before step (b), said method comprises the following step:
(aa) releasably connecting said brush connector to said rotary motor by friction-fitting at least a portion of said shaft inside said coupling portion cavity, and releasably connecting said brush to said brush connector by releasably friction-fitting said brush shank second end in said tubular socket portion.

In one embodiment, said brush, said brush connector and said motor shaft define a common longitudinal axis, and during step (b), said brush is spun along said common longitudinal axis to cause said bristles to fan out radially and to cause centrifugal acceleration and expulsion from said tuft of bristles of dust particles lodged between said bristles.

In one embodiment, after step (b), said method comprises the step of sweeping said bristles of said dusting tool against a delicate surface for removing dust from the latter.

In one embodiment, after step (b), said method comprises the step of bringing said bristles of said dusting tool in closely spaced fashion from a delicate surface for removing dust from the latter.

### DESCRIPTION OF THE DRAWINGS

In the annexed drawings:

FIG. 1 is a perspective view of a dusting tool according to one embodiment of the present invention;

FIG. 2 is a front elevation of the dusting tool of FIG. 1 with the handle member and the brush connector partly broken, and showing how the bristles of the brush fan out and are rid of dust when the user activates the dusting tool;

FIG. 3 is an exploded front perspective view of two dusting tools according to the embodiment of FIG. 1, the two dusting tools each having a brush and corresponding brush connector of different sizes; and

FIG. 4 is a partially exploded, front elevation view of a dusting tool according to an alternate embodiment of the present invention.

### DETAILED DESCRIPTION OF THE EMBODIMENTS

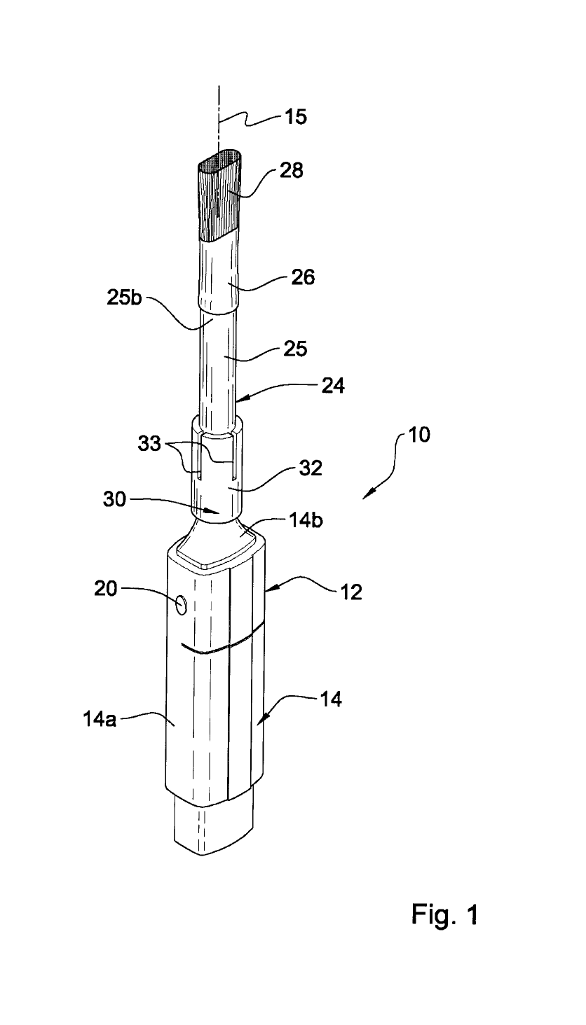

FIGS. 1-3 show a portable dusting tool 10 for digital camera sensors according to one embodiment of the present invention. Sensor dusting tool 10 comprises a handle member 12, in turn comprising a casing 14. Casing 14 defines an elongated main body portion 14a, and a neck portion 14b extending from one end of main body portion 14a.

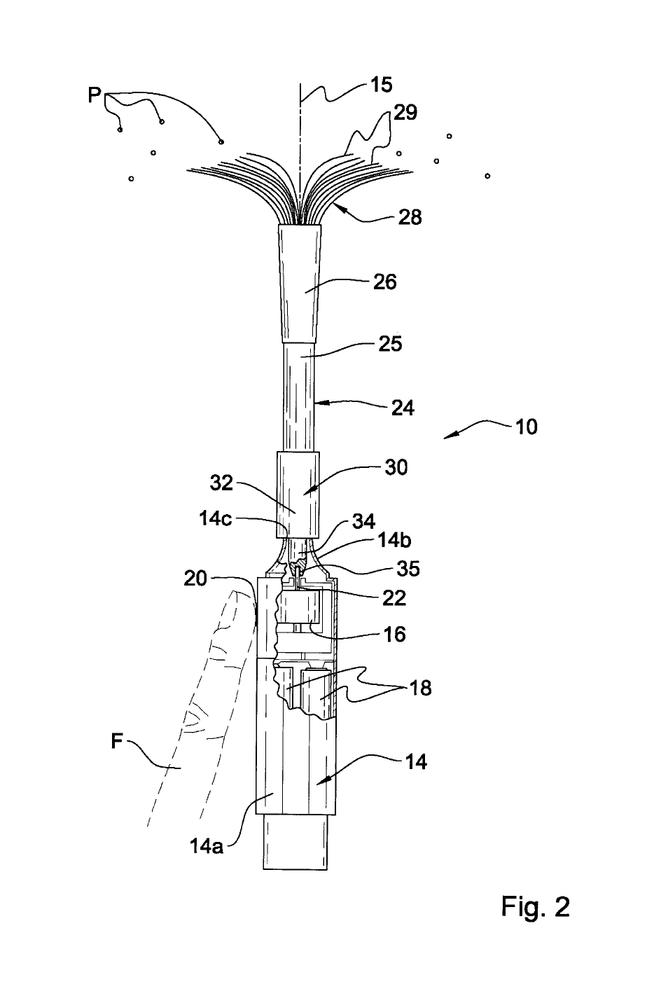

Casing 14, as can be seen in FIG. 2, is at least partially hollow and comprises a brush actuator therein, such as an electric rotary motor 16 powered by batteries 18. Batteries 18 are electrically connected to motor 16 as known in the art, for example by wires (not shown). Handle member 12 is also provided with a switch 20 controlling the selective powering of motor 16 by batteries 18, and which the user can depress with his finger F (as suggested in FIG. 2) to activate motor 16.

Motor 16 comprises a rotary shaft 22 connected to and rotating as one with the rotor (not shown) of motor 16. Shaft 22 extends within the hollow casing neck portion 14b.

Dusting tool 10 also comprises a duster member connected to the brush actuator. More particularly, dusting tool 10 is provided with a duster brush 24 operatively coupled to motor 16 through the instrumentality of a brush connector 30. Brush connector 30 comprises a cylindrical and tubular socket portion 32, in turn having an open top to allow insertion of the butt end portion of duster brush 24 therein. Socket portion 32 defines four slots 33 extending from its top rim end towards its bottom end and stopping short of the latter. Slots 33 allow the sections of socket 32 therebetween to radially outwardly spread apart as duster brush 24 is inserted in socket portion 32.

Moreover, brush connector 30 also comprises an elongated coupling pin 34 tapering towards its outer end, integrally and coaxially affixed to the bottom end of elongated socket portion 32. The outer free end of coupling pin 34 is centrally and axially bored, and an elongated and cylindrical cavity 35 thus extends coaxially along coupling pin 34 (only shown in FIG. 2).

Brush connector 30 can be coupled to motor 16 by inserting coupling pin 24 in the opening 14c at the outermost end of casing neck portion 14b, such that the motor's shaft 22 becomes snugly friction-fitted in cavity 35 of coupling pin 34.

As mentioned above, brush connector 30 is for operatively coupling the duster brush 24 to the motor 16. Duster brush 24 comprises a shank 25, made of wood for example, and whose butt end portion 25a is destined to be received and friction-fitted in the lumen of brush connector socket portion 32. Shank 25, at its upper end portion 25b, comprises a brush head formed of a ferrule 26 holding a bunch of bristles 29 in a tuft 28. Bristles 29 are destined to be swept about the sensor of a digital camera to pick up and collect dust that may be present thereon, as described hereinafter.

Casing 14, motor shaft 22, brush 24, connector socket portion 32 and coupling pin 34, are all elongated structures and are arranged coaxially to each other, and define a common longitudinal axis 15.

Bristles 29 are preferably made of a synthetic material, e.g. a polyamide material such as Nylon®, but could also be made of a natural material such as feather, wool, or fur. Moreover, bristles 29 are imparted with the following characteristics:
They are preferably soft and resilient. If the bristles are not flexible and resilient enough, they will be prone to breaking during use, and thus broken pieces of bristles may become lodged in the sensor chamber (not shown) in which the camera sensor is nested. Moreover, softer and more resilient bristles are less prone to breaking and are thus more durable. Finally, the bristles need to be delicate enough to be swept about a sensitive surface (e.g. that of a camera sensor) without scratching it.
They preferably have a thickness ranging between 40 to 60 μm.
They have an enhanced electrostatic charge build-up capability. The bristles can readily accumulate electrostatic charges, in order to be able to electrostatically attract dust particles and other macroscopic (e.g. maximum total length of 15 mm) and preferably microscopic impurities (e.g. minimum total length of 1 μm). This characteristic could be imparted to the bristles either (1) during pre-processing, by producing the bristles out of a material having inherent electrostatic charge build-up capabilities; or (2) during post-processing, by applying a chemical or ionization treatment to the produced bristles.
Enhanced resistance to chemical substances. This is a desirable characteristic since any alteration in chemical composition of the bristles will affect its capability to electrostatically attract dust.

The width of the tuft of bristles 28 should be adapted to the size of the optical sensor it is destined to be used on. The tuft of bristles 28 can have a width ranging for example between 1 and 60 millimetres, and should preferably be small enough to fit into the camera's sensor chamber, yet it should be large enough to sweep the entire surface of the camera's sensor in a single stroke. Moreover, ferrule 26 must have a smaller width than that of the tuft of bristles such that a clearance exists between ferrule 30 and the walls of the sensor chamber when the duster brush is used to sweep the sensor, hence preventing scratching by the ferrule of the sensor chamber walls. For example, a brush with a ferrule 26 having a width of 20 mm, and a tuft of bristles 29 having a width of 24 mm, should preferably be used when cleaning a full frame sensor having dimensions of 36 mm×24 mm.

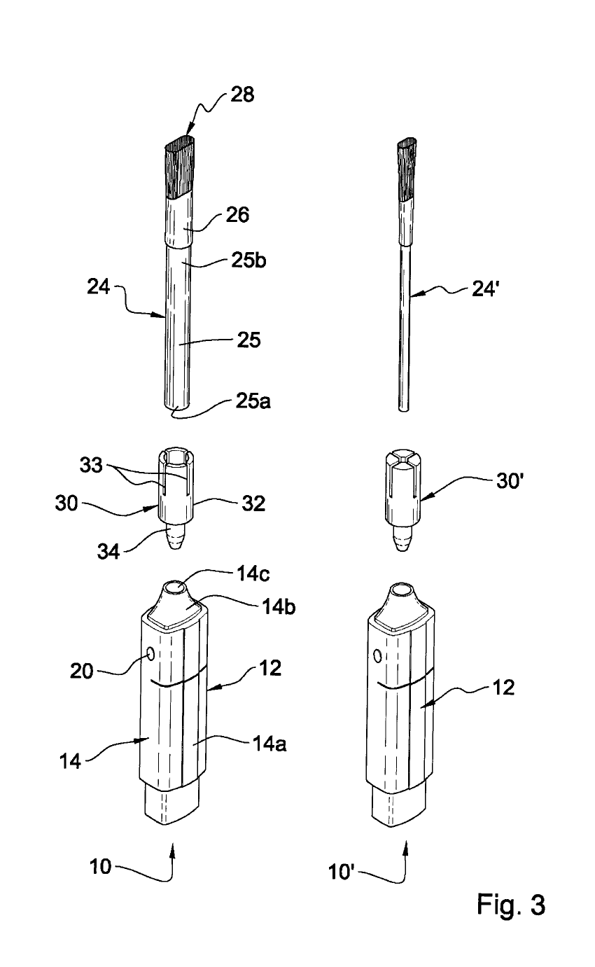

The dusting tool according to the illustrated embodiment is made modular in order to be able to receive brushes of different dimensions. This is illustrated in FIG. 3, where dusting tools 10 and 10′ in FIG. 3 have differently sized brushes 24, 24′ and complementary brush connectors 30, 30′ respectively. These brush/connector combinations, even though they have differing dimensions, can be coupled to a same handle member 12.

To use the dusting tool 10, it must first be assembled. To do so, the user first inserts batteries 18 in the battery housing if necessary. The user then selects a duster brush 24 of the desired dimensions and inserts the butt end portion 25a of its shank in the corresponding brush connector socket 32. The user then connects brush connector 30 to motor 16 by inserting its coupling pin 34 through casing neck portion opening 14c, and by friction-fitting motor shaft 22 in the coupling pin cavity 35.

Prior to dusting a surface such as a camera sensor, it is desirable to rid the tuft of bristles 28 from ambient dust particles that may have gravitated towards it, and/or to remove dust particles that may have remained within the tuft of bristles 29 after a previous use of the dusting tool. It is further necessary to electrostatically charge the bristles 29 in order for them to be able to electrostatically attract and collect dust from the surface to be dusted.

To do so, the user depresses switch 20, which activates motor 16 and consequently spins elongated brush 24 along its longitudinal axis at a substantially high speed. This causes the bristles 29 of the brush to fan out radially as illustrated in FIG. 2. The rotation of brush 24 has two effects:
the bristles 29 of the brush move rapidly relative to ambient air molecules. Bristles 29, as mentioned above, have the inherent capacity to easily build-up an electrostatic charge. Thus, the friction between the rotating bristles and the ambient air molecules causes the bristles to develop an increased electrostatic charge.
the dust particles P lodged between bristles 29 centrifugally accelerate and are expelled from the tuft of bristles 28.

Activating motor 16 thus charges the bristles 29 and concomitantly rids brush 24 from dust particles and various other impurities that may be lodged between its bristles 29, and prepare dusting tool 10 for use on a surface to be dusted.

The tip of the brush can then be inserted in the sensor chamber of the digital camera, and the tuft of bristles 28 can be swept across the surface of the camera sensor. Mechanical contact between the distal end portion of the bristles 28 and the camera sensor is possible but not essential. Indeed, bringing the tip of the bristles in closely spaced fashion to the camera sensor may be sufficient to enable the dust to be attracted by and gravitate towards the electrostatically charged bristles, and to be fully operational to dislodge dust. Since bristles 29 are electrostatically charged, dust particles present on the sensor's surface cling to the bristles of the brush, and are hence removed form the sensor surface.

Modifications to the above-described embodiment could be made without departing from the scope of the present invention. For example, the dusting tool could be provided with means enabling the user to select various motor speeds for example between 5000 to 20000 RPM in order to vary the rotation speed of the duster brush. Alternately, the duster actuator could be something else than a mere rotary motor; it could for example be a powered actuator selectively activated to engender the vibration, rotation, sonication, reciprocating axial motion, or a combination of these actions, of the duster brush 24 and its bristles 29, in order for the bristles to become electrostatically charged and for impurities lodged between the bristles to be expelled out of the brush.

Alternately, the motor could be replaced by an alternate duster actuator that does not require batteries, for example a manual actuator composed of a series of cooperating gears which can be set in motion by manually rotating a crank.

Alternately, the brush could be replaced by any suitable duster member of suitable shape and carrying a number of bristles, and where this duster member is operatively coupled to a suitable duster actuator.

It is also understood that the brush connector 30 providing modularity to the dusting tool, and releasably connecting the duster brush 24 to the motor 16 is optional. It is understood that any suitable fastening means, whether they be permanent or quick-release fastening means, could be used to fasten the duster member to the duster actuator. Alternately, the duster brush could be directly connected to the duster actuator in any conventional manner.

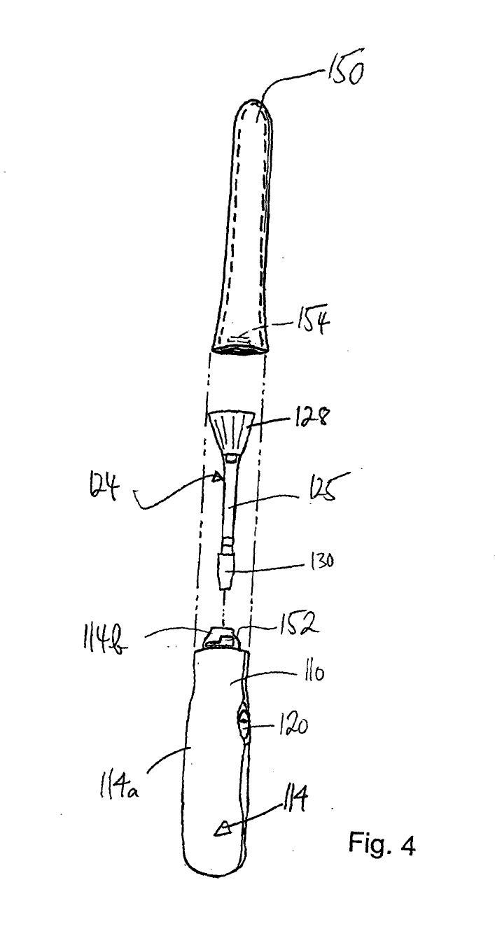

FIG. 4 shows a duster tool 110 according to an alternate embodiment of the present invention. Duster tool 110 comprises a handle member 112 defining a casing 114, in turn defining an ergonomically shaped main portion 114a and a neck portion 114b. Casing 114 houses a motor therein (not shown), the motor having a rotary shaft (not shown) extending at least partially in casing neck portion 114b and whose rotary movement is controlled by a switch 120. Moreover, duster tool 110 has a brush member 124 defining a tubular shank 125 (metallic for example), the upper end of which is pressed around a tuft of bristles 128. Shank 125 fixedly carries, at its bottom end, a connector member 130 (made of plastic for example). Connector member 130 defines a cavity therein (not shown), similar to cavity 35 of brush connector 30 of FIG. 2, into which can be snugly friction fitted the shaft of the duster tool's rotary motor. In the embodiment of FIG. 4, brush member 124 and the connector member 130 are fixedly assembled together, and it is this fixed assembly as a whole that is releasable from handle member 112. Moreover, duster tool 110 is provided with a hollow, elongated protective cap 150 which can be slipped around the brush 124 and secured to the casing 114 by twisting it in place to friction-fit a projection 154 made on the inner peripheral wall of the protective cap 150 within a groove 152 made into the casing neck portion 114b.

It is further noted that although the present cleaning tool has been described as a cleaning tool for digital camera sensors, the present cleaning tool could be used for cleaning other delicate surfaces, such as optics, i.e. the various glass elements of a camera lens, the mirror of a SLR camera, negative film, transparencies, electro-optical devices such as digital imaging devices, etc.

1. A dusting tool, comprising:
a selectively activated duster actuator;
a duster member connected to said duster actuator and carrying a number of bristles, said bristles having an enhanced electrostatic charge build-up capability;
wherein said duster actuator can be activated to actuate said duster member, for electrostatically charging said bristles and for concomitantly causing dust to be dislodged from said bristles.

2. The dusting tool according to claim 1,
wherein said dusting tool is portable.

3. The dusting tool according to claim 2,
wherein said duster actuator is a rotary motor.

4. The dusting tool according to claim 3,
further comprising a casing into which said rotary motor is at least partially received.

5. The dusting tool according to claim 3,
wherein said duster member is a brush defining an elongated shank connected at a first end to said rotary motor, and carrying a tuft of said bristles at a second end.

6. The dusting tool according to claim 5,
further comprising a brush connector releasably coupled to said rotary motor and carrying said brush, said brush being thus operatively and releasably coupled to said rotary motor through the instrumentality of said brush connector.

7. The dusting tool according to claim 6,
wherein said rotary motor defines a shaft, wherein said brush connector defines a tubular socket portion and a coupling portion defining a cavity therein, and wherein said brush connector is releasably connected to said rotary motor by friction-fitting at least a portion of said shaft inside said coupling portion cavity, and said brush is releasably connected to said brush connector by releasably friction-fitting said brush shank second end in said tubular socket portion.

8. The dusting tool according to claim 7,
wherein said brush, said brush connector and said rotary motor shaft define a common longitudinal axis, and wherein upon activation of said rotary motor said brush is spun along said common longitudinal axis to cause said bristles to fan out radially for engendering centrifugal acceleration and expulsion from said tuft of bristles of dust particles lodged within said bristles.

9. The dusting tool according to claim 1,
wherein the enhanced electrostatic charge build-up capability of said bristles is imparted to said bristles during pre-processing by producing said bristles out of a material having inherent electrostatic charge build-up capabilities.

10. The dusting tool according to claim 9,
wherein said bristles are made of polyamide.

11. The dusting tool according to claim 9,
wherein each of said bristles has a thickness within the range of 40 to 60 micrometers.

12. The dusting tool according to claim 1,
wherein the electrostatic charge build-up capability of said bristles is imparted to said bristles during post-processing by applying a chemical to said bristles.

13. The dusting tool according to claim 1,
wherein the electrostatic charge build-up capability of said bristles is imparted to said bristles during post-processing by applying a ionization treatment to said bristles.

14. The dusting tool according to claim 1,
wherein said electrostatic charge build up capability of said bristles enables attraction of macroscopic particles up to 15 millimetres in total length.

15. The dusting tool according to claim 1,
wherein said electrostatic charge build up capability of said bristles enables attraction of microscopic particles down to 1 micrometre in total length.

16. A method of use of a dusting tool, said method comprising the steps of:
(a) providing a portable dusting tool, comprising a selectively activated duster actuator, and a duster member carrying a number of bristles and connected to said duster actuator, said bristles having an enhanced electrostatic charge build-up capability; and
(b) activating said duster actuator to actuate said duster member, to electrostatically charge said bristles and to concomitantly cause impurities lodged between said bristles to be dislodged therefrom.

17. The method according to claim 16,
wherein said duster actuator comprises a rotary motor defining a shaft, said dusting tool comprises a brush connector defining a tubular socket portion and a coupling portion defining a cavity therein, and said duster member is a brush having an elongated shank defining a first end and a second end, said bristles being carried at said shank second end, and wherein before step
(b), said method comprises the following step:
(aa) releasably connecting said brush connector to said rotary motor by friction-fitting at least a portion of said shaft inside said coupling portion cavity, and releasably connecting said brush to said brush connector by releasably friction-fitting said brush shank first end in said tubular socket portion.

18. The method according to claim 17,
wherein a tuft of said bristles are carried at said shank first end, and wherein said brush, said brush connector and said motor shaft define a common longitudinal axis, and wherein during step (b), said brush is spun along said common longitudinal axis to cause said bristles to fan out radially and to cause centrifugal acceleration and expulsion from said tuft of bristles of dust particles lodged between said bristles.

19. The method according to claim 16,
wherein after step (b), said method comprises the step of sweeping said bristles of said dusting tool against a delicate surface for removing dust from the latter.

20. The method according to claim 16,
wherein after step (b), said method comprises the step of bringing said bristles of said dusting tool in closely spaced fashion from a delicate surface for removing dust from the latter.
